(19) United States
(12) Patent Application Publication
(10) Pub. No.: US 2023/0419744 A1
(43) Pub. Date: Dec. 28, 2023

(54) METHOD AND ELECTRONIC CONTROL UNIT FOR MANAGING AT LEAST ONE WIRELESS CONNECTIVITY SERVICE FOR AT LEAST ONE APPLICATION IN A VEHICLE

(71) Applicant: Continental Automotive Technologies GmbH, Hannover (DE)

(72) Inventor: Hojin Kim, Regensburg (DE)

(73) Assignee: Continental Automotive Technologies GmbH, Hannover (DE)

(21) Appl. No.: 18/038,850

(22) PCT Filed: Oct. 21, 2021
(86) PCT No.: PCT/EP2021/079169

§ 371 Date: May 25, 2023

(30) Foreign Application Priority Data
Nov. 25, 2020 (EP) 20209828.1

(51) Int. Cl. G07C 5/00; H04W 72/543

(52) U.S. Cl. CPC G07C 5/008; H04W 72/543

(57) ABSTRACT

Disclosed are a method and an electronic control unit for managing at least one wireless connectivity service for at least one application in a vehicle, wherein the vehicle comprises several connectivity devices running at least one wireless connection, wherein the respective wireless connectivity service is based on the at least one wireless connection. For each connectivity service at least one of the connectivity devices is selected that yields a minimized result of a connectivity evaluation function, wherein the connectivity evaluation function maps a pre-defined data set of a connectivity device master map for the traffic type of the connectivity service onto a respective evaluation value for each connectivity device, and the respective wireless connectivity service is established using the respective wireless connection of each selected connectivity device.

The invention is concerned with a method and an electronic control unit for managing at least one wireless connectivity service for at least one application in a vehicle, wherein the vehicle comprises several connectivity devices running at least one wireless connection.

Over the last couple of years, an increasing number of vehicles started to be equipped with diverse configurations of connectivity functionalities such as Cellular, Wi-Fi, Bluetooth/Low Energy, GNSS (global navigation satellite system) along with broadcast radio. Each connectivity functionality continues to evolve based on the associated standardizations (e.g., Cellular—2G/3G/4G/5G, Wi-Fi—11n/ac/ax, Bluetooth—BT3/4/5, GNSS—multi-frequency precise positioning). Additional connectivity solutions are on the rise for new automotive use cases and killer applications such as V2X (so called vehicle-to-everything), UWB (ultra wideband), LPWAN (low-power wide-area network). Also, Gigabit Ethernet is getting popular for attaching to in-vehicle connectivity group for high data transfer with multimedia content traffic. The in-vehicle connectivity functionalities have been located in many different places inside the vehicle due to several different reasons. The typical form factor includes a TCU (telematics control unit) box that contains emergency call, cellular data transfer as well as wired connections such as CAN/Ethernet (CAN—controller area network). Another exemplary type is an independent modular level solution of connectivity that can be attached on the so-called IVI (in-vehicle infotainment) system. Another solution is based on the so-called connected gateway, the enhanced version of general gateway box that is another target area for connectivity placement so that both wireless and wired connectivity functionalities can be supported. Lastly, smart antenna is the very recent concept of in-vehicle connectivity solution and its location is generally roof-top area with the integrated bunch of antennas and electronic board together so that coax cable saving and vehicle weight reduction can be achieved with lower wiring connection complexity by guaranteeing the required connectivity performances.

As many connectivity functionalities are integrated into vehicle, there are critical challenges to overcome due to support of various automotive use cases using in-vehicle connectivity solutions. Those challenges include
Increasing thermal heat with higher power dissipation,
Increasing power consumption with limited power supply budget
Mechanical size limitation due to diverse vehicle design concepts
RF (radio frequency) performance limitation due to electromagnetic power radiation (especially SAR—Specific Absorption Rate),
Absence of backup connectivity solution(s) in case of any in-vehicle connectivity failure or malfunction for specific automotive use case support,
Higher functional requirements from vehicle manufacturers about cross-functional operations of different connectivity solutions such as, e.g., Cellular+WiFi, Cellular+Ethernet, V2X+GNSS,
Higher functional optimization of navigation/HD map with in-vehicle connectivity for autonomous driving.

The major challenges to overcome for the full-featured connectivity operations are especially:
Increasing thermal heat with high power dissipation occurs and it results in connectivity malfunction, operation failure or even circuit breakdown.
Increasing power consumption is on demand due to heavy data traffic load through in-vehicle connectivity operations and it also results in serious impact on limited power budget.
Electromagnetic power radiation issue occurs due to the placement of in-vehicle connectivity such as roof-top and any SAR violation needs to be managed.
In-vehicle connectivity failure or malfunction can occur due to thermal heat or physical damage
Lack of functional optimization of in-vehicle connectivity with navigation/HD map (HD—high detail) for autonomous driving.

In the following, the term “connectivity service” refers to a data transmission service provided for an application software that is run in an electronic control unit (ECU) of a vehicle, wherein the data transmission service comprises transferring the data between the application and a communication partner outside the vehicle. The transmission of the data is achieved on the basis of one single wireless connection or several combined wireless connections. Each wireless connection is operated or run by a respective electronic circuitry that is referred to as connectivity device in the sequel. The connectivity devices may be linked to an antenna configuration comprising one or more antenna.

It is an object of the present invention to provide a management for a respective connectivity service for one or more applications in a vehicle such that the underlying connectivity devices avoid at least some of the above-described technical problems.

The object is accomplished by the subject matter of the independent claims. Advantageous developments with convenient and non-trivial further embodiments of the invention are specified in the dependent claims, the following description, and the drawings.

The invention provides a method for managing at least one wireless connectivity service for at least one application in a vehicle. The invention is based on a setup where the vehicle comprises several connectivity devices running at least one wireless connection. As has been explained above, the respective wireless connectivity service is based on the at least one wireless connection.

According to the inventive method a connectivity management unit, ICMU, performs the following steps:
operating a link quality estimator, LQE, for determining a respective link quality metric, LQM, of the respective wireless connection of each of the connectivity devices,
operating a transmission, Tx, power estimator, TPE, for determining a respective average radiated transmission power P_{T}, and a respective SAR level P_{SAR_PWR} and a respective power consumption P_{C} of each connectivity device,
operating a Quality-of-service, QoS, estimator, QSE, for determining a respective QoS mode metric, QMM, that quantifies a suitability of the respective wireless connection of each of the connectivity devices for performing the respective wireless connectivity service for at least one pre-defined traffic type t,
operating a connectivity metric generator, CMG, for providing a connectivity device master map, CDMM, that lists the output of the link quality estimator LQE, the Tx power estimator, TPE, and the QoS estimator, QSE.

When the at least one application signals a respective demand for the respective wireless connectivity service, the connectivity management unit, ICMU, performs the steps of
determining for the respective application (app) the respective traffic type t based on a service class of the application, e.g. one of the service classes streaming app (like video streaming) or interactive app (like Internet-browsing or telephoning or video conferencing) or non-real-time data transfer (like data download),
operating a connectivity mode selector, CMS, for selecting for each connectivity service at least one of the connectivity devices for which a pre-defined connectivity evaluation function yields a maximized result, wherein the connectivity evaluation function maps a pre-defined data set or data sub-set of the CDMM for the determined traffic type t onto a respective evaluation value, and
establishing the respective wireless connectivity service using the respective wireless connection of each selected connectivity device.

The invention provides the benefit that the connectivity service is established on the basis of those connectivity devices that at the time of the demand provide optimized link quality and at the same time minimized power consumption. An application may signal the need or demand of a connectivity service for exchanging data with an external service or device (i.e. outside the vehicle) and the method will choose the wireless connection that is optimal in the sense of the connectivity evaluation function, thus considering link quality, transmission power restrictions (SAR) and available QoS modes. The application will be serviced with an optimal choice of available wireless connections.

The described LQE, TPE, QSE and CMG may be implemented on the basis of software implementation for an electronic processor circuitry with processor, memory, power supply and interface functionalities. They may update their output (e.g. LQM, QMM) periodically and the CDMM may be updated accordingly. Update intervals may be adjusted flexibly as it is dependent on how it needs to be customized for specific implementation cases such as in a range from millisecond to minute basis (e.g. 1 ms to 10 min). After such an update, already running connectivity services may be re-configured based on the connectivity evaluation function.

The invention also comprises embodiments that provide additional technical advantages.

One embodiment comprises that the connectivity devices are provided in n electronic control units, ECU, with index i and each ECUᵢ provides kᵢ of the connectivity devices, such that each connectivity device is identified by an index i of its ECUᵢ and an index j of the kᵢ connectivity devices of the ECUᵢ and wherein for selecting the at least connectivity device the following maximization of the following connectivity evaluation function is performed:

$$max \frac{{\sum }_{i , j} {w}_{i , j} R ( i , j )}{{\sum }_{i , j} {P}_{T} ( i , j ) + {\sum }_{i , j} {P}_{C} ( i , j )} ,$$

wherein
w_{i,j} is a pre-defined weighting factor of the i-th ECU and its j-th connectivity device,
R(i,j) is a utility function of the i-th ECU and its j-th connectivity device as defined by
R(i,j)=6{QMM(i,j,t), LQM(i,j)}, wherein δ{ } is a pre-defined function for combining QMM and LQM. w_{i,j} and δ{ } may be chosen by the skilled person to adapt the inventive method to the needs of a specific model of a vehicle.
P_{T}(i,j) is the average radiated power of i^{th} ECU and j^{th} connectivity device, P_{C}(i,j) is the power consumption of i^{th} ECU and j^{th} connectivity device.
P_{T}(i,j) may be the additional transmission power value needed to operate the requested connectivity service with the i^{th} ECU and j^{th} connectivity device,
P_{C}(i,j) may be the is the additional power consumption value needed to operate the requested connectivity service with the i^{th} ECU and j^{th} connectivity device.

The maximization max( ) may be performed over all available connectivity devices, i.e. all indices i,j. Overheated or otherwise deactivated connectivity devices may be excluded.

One embodiment comprises that the following additional steps of the connectivity management unit, ICMU: detecting, if one of the connectivity devices overheating for each connectivity device, and if an overheated connectivity device is detected, initiating a thermal management function, and if the thermal management function fails to mitigate the overheating, excluding the connectivity device from the selection. This provides the benefit of also considering thermal issues in the management of the connectivity services.

One embodiment comprises that the thermal management function comprises the steps of:
operating a thermal status monitor, TSM, for determining available respective thermal mitigation modes, TMMs, for different temperature ranges of each connectivity device, and switching from a current TMM to another new TMM, if the temperature of the connectivity device is in the temperature range of the new TMM, and/or
switching to another one of the connectivity devices if the wireless connection of the other connectivity device is compatible with the wireless connection of the overheated connectivity device according to a predefined compatibility criterion, and/or
finding an interworking connectivity device and routing a part of a data traffic of the overheated connectivity device to the interworking connectivity device instead of the overheated connectivity device.

Thus, as thermal heat gets higher in an environment along with high power dissipation, functional level thermal management may be considered to avoid the worst situation such as operation failure or circuit breakdown. That is, some type of thermal mitigation mechanism may be applied to its own connectivity service (e.g. cellular, Wi-Fi) so that any malfunction or system breakdown can be prevented. Those thermal mitigation approaches may include: data throttling, maximum Tx power back-off, limit/disable data transmission modes, voice call shutdown or service mode reduction. Additionally or alternatively, another connectivity device may be used for the connectivity service and/or at least a part of the data traffic may be routed over another connectivity device. Note that on detection of an overheated connectivity device, a connectivity service that is already running may be reconfigured by the thermal management function. The compatibility criterion may define that the new connectivity device that is to take over the data traffic must support the same traffic type t as the overheated connectivity device.

One embodiment comprises that the thermal status monitor, TSM, comprises:
receiving sensor data for each of the connectivity devices,
generating mapping table of temperature levels, TLs, of the connectivity devices,
generating a look-up table of the thermal mitigation modes, TMMs, with temperature threshold levels, THs, for each of the connectivity devices, wherein the temperature levels, TL, each describe a temperature range comprising several temperature values and wherein the respective temperature threshold level, TH, indicates one of the temperature levels, TLs. Using temperature ranges provides the benefit that a hysteresis effect is achieved for switching between the different thermal mitigation modes, TMMs.

One embodiment comprises that the thermal mitigation modes, TMMs, comprise at least one of: data throttling, maximum Tx power back-off, limiting/disabling data transmission modes, shutdown or service mode reduction. It is to be noted that a thermal mitigation mode, TMM, may also have an effect on the link quality and the QoS mode, as, for example, data throttling, may reduce the bandwidth of a wireless connection. Thus, after switching to another thermal mitigation mode, TMM, the already running connectivity services may be re-configured or re-distributed onto at least one other connectivity devices based on the connectivity evaluation function.

One embodiment comprises that the thermal management function comprises:
verifying that applying the thermal management function results in a transmission power P_{T} of each wireless connection below the respective SAR level P_{SAR_PWR} for each connectivity device and/or
verifying that applying the thermal management function results in a link quality that meets the required QoS mode metric, QMM, for each running connectivity service. This prevents a detrimental change in any running connectivity service as it may otherwise be cause by applying, for example, a different thermal mitigation mode.

One embodiment comprises that the transmission power estimator, TPE, comprises:
receiving proximity sensor data signaling a human body proximity to a respective antenna configuration (i.e. the one or more antenna) used by the respective connectivity device,
determining the respective SAR level P_{SAR_PWR} based on the proximity sensor data. The SAR level is thus beneficially adapted to the current situation in the vehicle. The proximity sensor data may be generated by, e.g., a camera with an image processing unit, a proximity sensor and/or a seat occupation sensor. For electromagnetic power radiation, SAR violation can be serious as it has global standard guidelines for its limits. It is caused by electromagnetic power radiation and can be violated depending on the distance between connectivity device location and human head/body if any connectivity transmission is operated at maximum power level. Especially for so called smart antenna (self-adapting antenna), this issue could occur due to the placement of in-vehicle connectivity such as roof-top as passengers are seated and their heads could be close to the device. However, a proximity sensor may be used to program a connectivity device to reduce RF emission power when a device is near a human body part.

One embodiment comprises that the transmission power estimator, TPE, additionally comprises:
receiving Tx power information of each of the connectivity devices,
generating a mapping table of Tx power delta metrics TPM of the connectivity devices for the connectivity device master map, CDMM, wherein the Tx power delta metrics, TPM, is calculated for the respective connectivity device as:

TPM=P_{SAR_PWR}−P_{T}

wherein the TPM is required to be larger or equal to 0. The TPM can be beneficially used for determining which connectivity device can take how much additional data traffic before reaching its SAR level. This results in an additional criterion for choosing a specific connectivity device for a newly demanded connectivity service as establishing the connectivity service results in additional data traffic in the selected connectivity devices. P_{T} can be the current power level (without the requested connectivity service) in order to monitor the remaining headroom or it can be the power level including the connectivity service in order to verify that performing the connectivity service with the respective connectivity device will not result in a value TPM<0.

One embodiment comprises that the link quality estimator, LQE, comprises:
receiving link quality information for each of the connectivity devices,
from the link quality information generating a look-up table of link quality metrics, LQM, of the connectivity devices, wherein the link quality metric, LQM, indicates a set of measurements, in particular the known measures SNR, RSSI, PER, and/or
from the link quality information generating a mapping table of link quality levels, LQLs, from the link quality metrics, LQMs, of the connectivity devices, wherein the link quality level, LQL, indicates the connection quality of each given connectivity devices, in particular as one of highly stable, stable, unstable, highly unstable, into P levels. Using such tables reduces the processing time for determining the optimal connectivity devices.

One embodiment comprises that the connectivity devices are provided in n electronic control units, ECU, with index i and each ECUᵢ provides kᵢ of the connectivity devices, such that each connectivity device is identified by an index i of its ECUᵢ and an index j of the kᵢ connectivity devices of the ECUᵢ and wherein the QoS estimator, QSE, comprises:
receiving supported k QoS mode components Mᵢⱼ^{q} of the connectivity devices,
generating a mapping table of the QoS mode metrics, QMMs, of the connectivity devices, wherein the respective QMM is calculated as

$$Q M M ( i , j , t ) {=}^{Δ} {\sum }_{q = 1}^{k} {w}_{q} \times {f}_{q} ( {M}_{i j}^{q} ( t ) )$$

wherein
QMM(⋅) is the QoS mode metric of the i-th ECU and its j-th connectivity device, t is the traffic type index,
w_{q} is a pre-defined weight value for signaling a pre-defined priority level of q-th QoS mode metric, and
f_{q}(Mᵢⱼ^{q}) is a pre-defined function of the q-th QoS mode component Mᵢⱼ^{q}.

This provides the benefit that for a given traffic type t, the suitability of the connectivity device is expressed in a single value. f_{q}( ) allows to combine values of different units (e.g. delay in Milliseconds and bandwidth in bits per second).

One embodiment comprises that as the QoS mode components Mᵢⱼ^{q} at least one of the following quantities is provided: packet throughput, error rate, delay, bandwidth, jitter.

One embodiment comprises that as the pre-defined traffic types t, at least one of background, best effort, voice, video is provided. For example, a voice over IP, VoIP, telephone call is of traffic type “voice”.

One embodiment comprises the following additional steps:
generating a Connectivity Quality Data Map, CQDM, based on the connectivity device master map, CDMM, to indicate an in-vehicle connectivity device quality level for each wireless connection by temporally quantizing a pre-defined data set or data subset of the CDMM using a pre-defined averaging function for a pre-defined average time interval T, and/or
generating a Connectivity Zone Map, CZM, by geographically quantizing geographical locations by mapping with the Connectivity Quality Data Map, CQDM, into pre-defined connectivity zones such that the data of the CQDM is mapped onto geographical location information depending on the location where they applied. A suitable averaging function may comprise the sum or integral of the respective metric values (e.g. TMM, QMM, LQM, LQL) over the time interval T may be used. Such maps may be used for planning a connectivity service. For example, planning ahead for a known route can be provided by choosing a connectivity device that will be able to provide the connectivity device with at least a predefined minimum reliability value derived from the CZM for that connectivity device.

The method also comprises the combinations of the features of the described embodiments.

The invention also comprise an Electronic control unit with an electronic processor circuitry, wherein the electronic control unit is designed to control data traffic between a) at least one electronic control unit running at least one application and b) at least one electronic control unit running at least one connectivity device and wherein the electronic processor circuitry is designed to perform an embodiment of the inventive a method.

The invention also comprises a vehicle with the described electronic control unit. The vehicle may be a passenger vehicle or a truck.

In the following an exemplary implementation of the invention is described. The figures show:

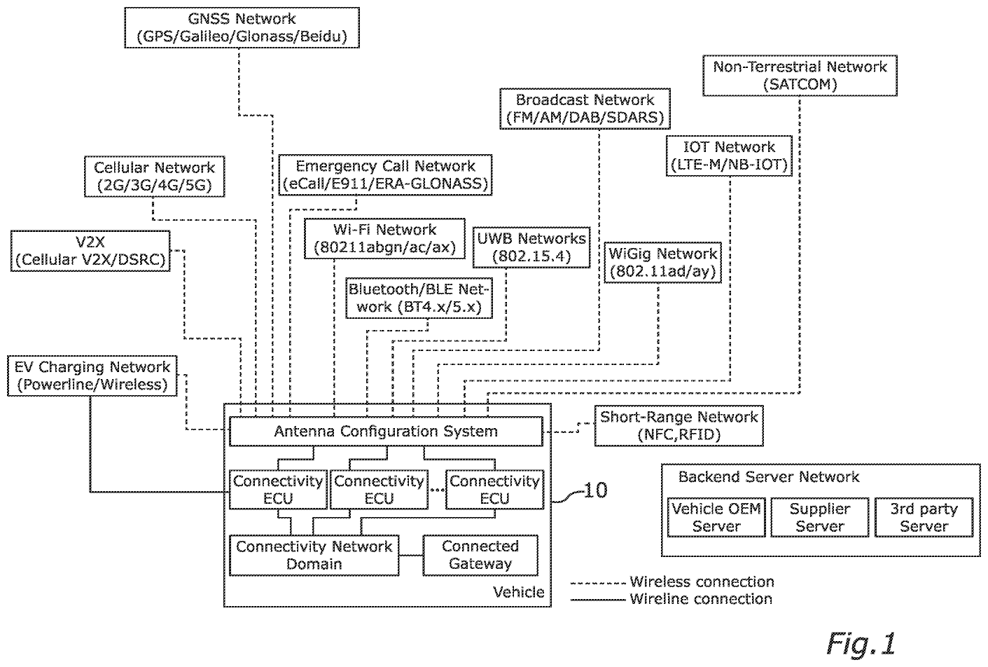

FIG. 1 a schematic illustration of an embodiment of the vehicle with the inventive electronic control unit;

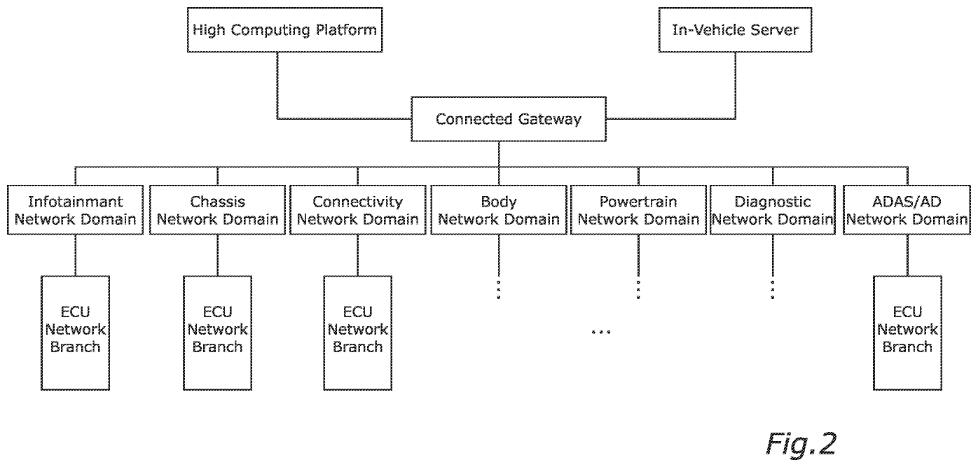

FIG. 2 a schematic illustration of network domains of the vehicle;

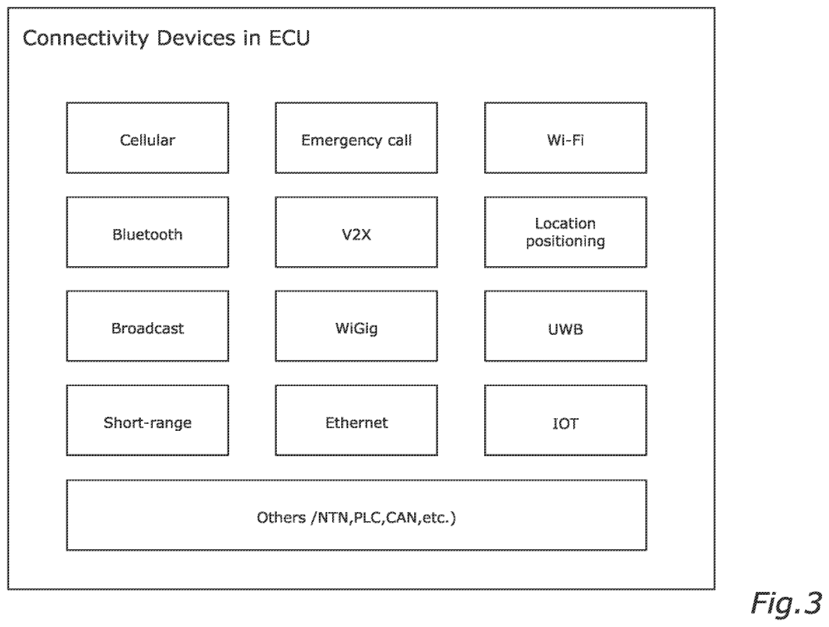

FIG. 3 a schematic illustration of a connectivity ECU with connectivity devices;

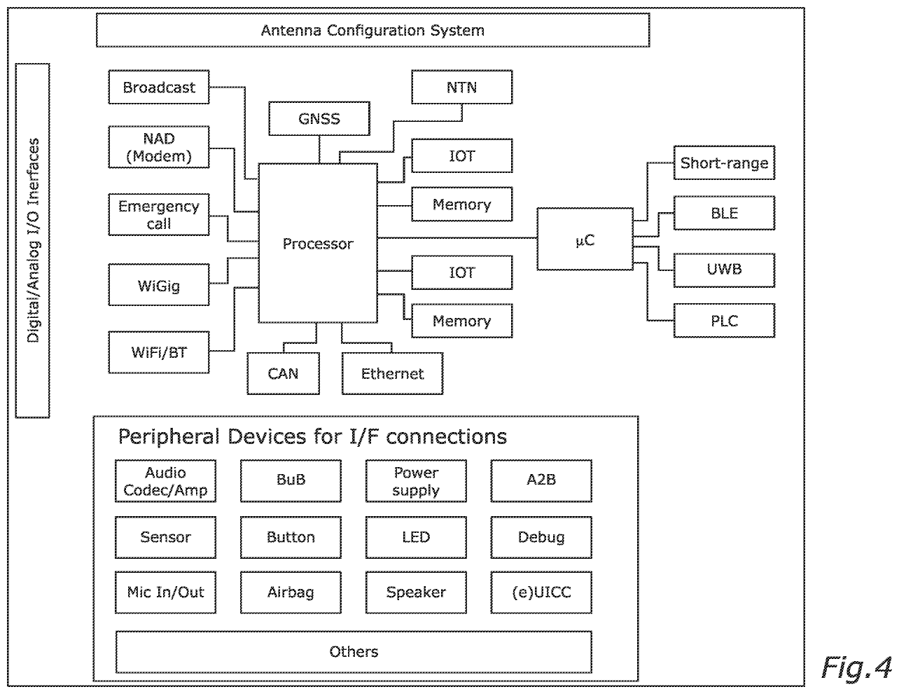

FIG. 4 a schematic illustration of a design of the connectivity ECU;

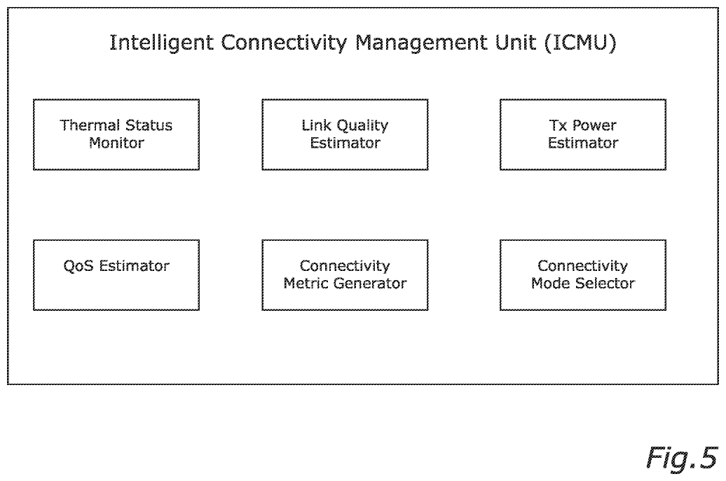

FIG. 5 a functional block diagram of an exemplary connectivity management unit ICMU;

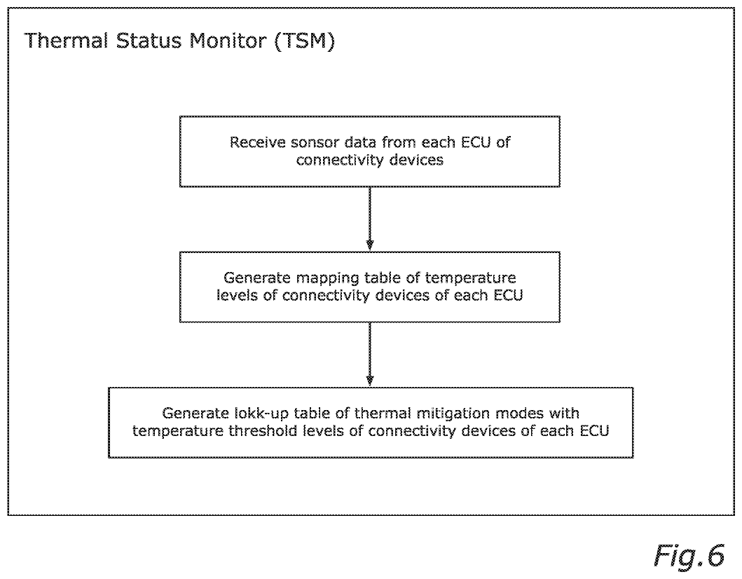

FIG. 6 a functional block diagram of an exemplary thermal status monitor TSM;

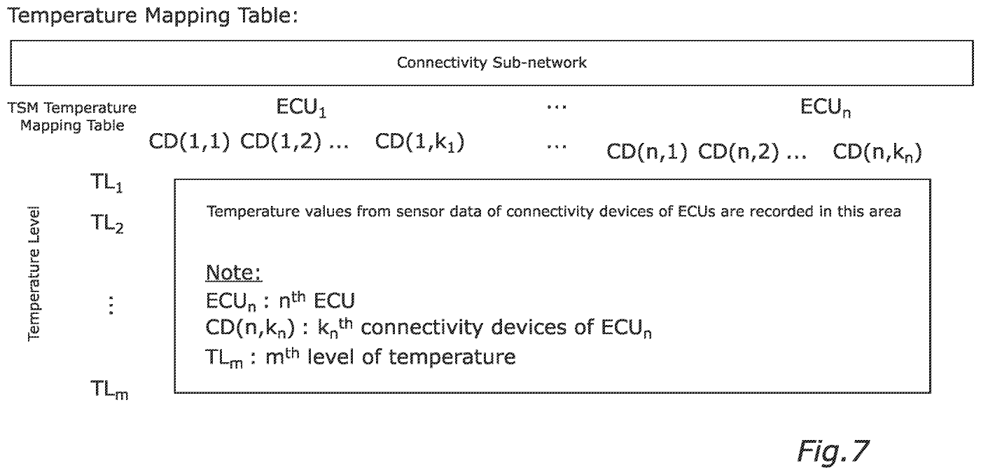

FIG. 7 an exemplary temperature mapping table;

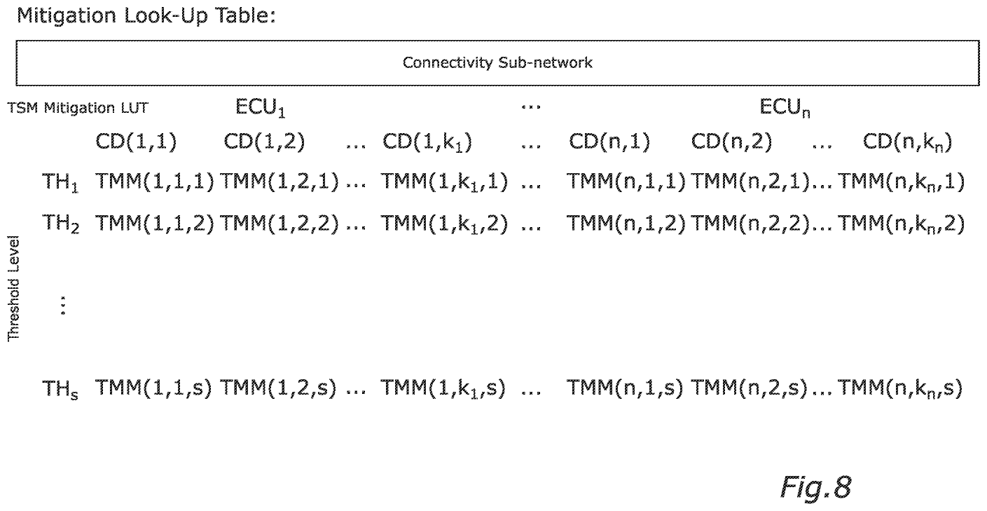

FIG. 8 an exemplary mitigation look-up table;

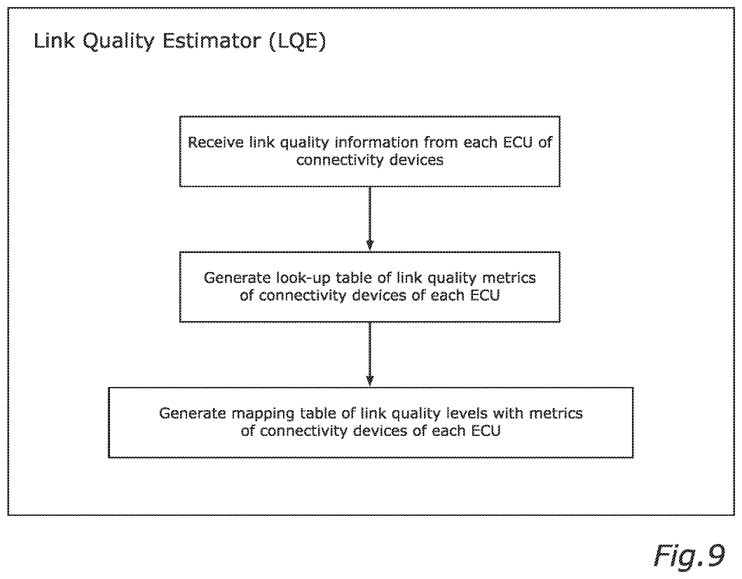

FIG. 9 a functional block diagram of an exemplary link quality estimator LQE;

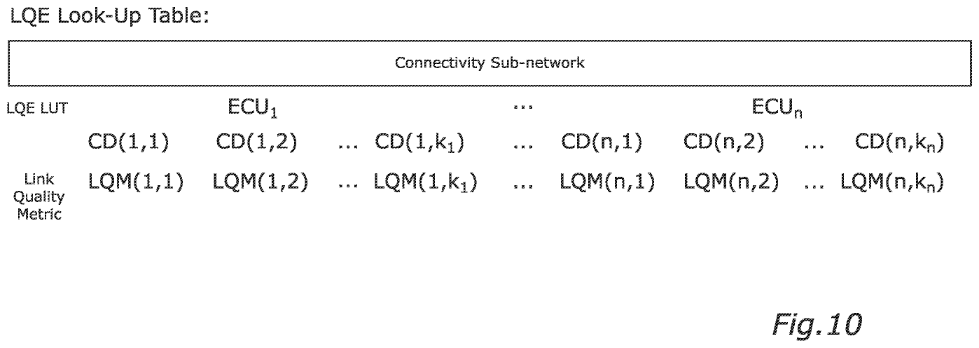

FIG. 10 an exemplary LQE look-up table;

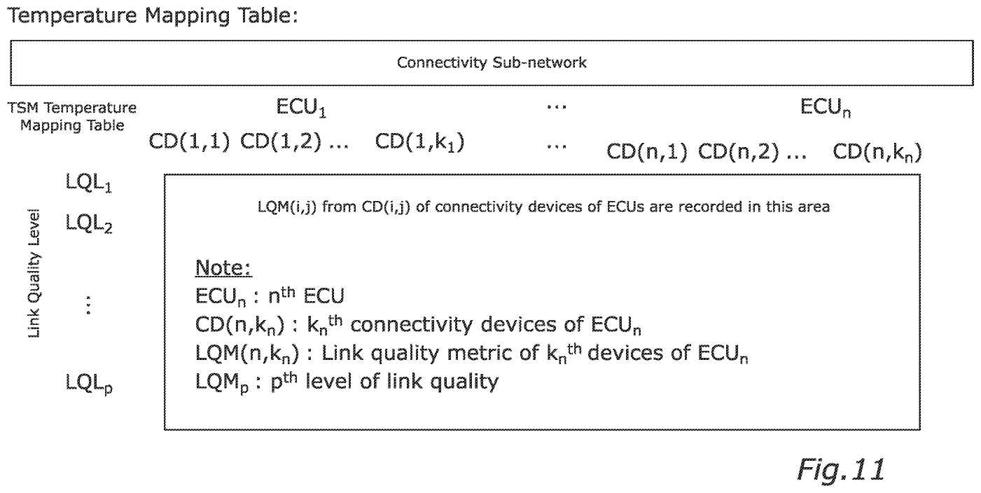

FIG. 11 an exemplary LQE mapping table;

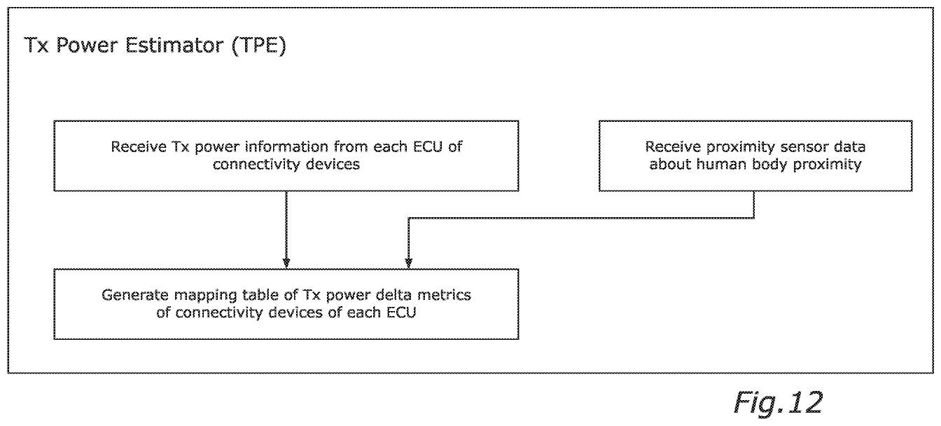

FIG. 12 a functional block diagram of an exemplary Tx power estimator TPE;

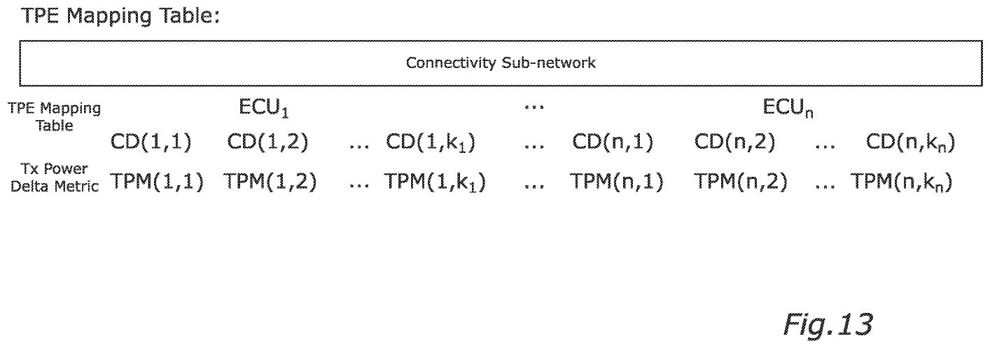

FIG. 13 an exemplary TPE mapping table;

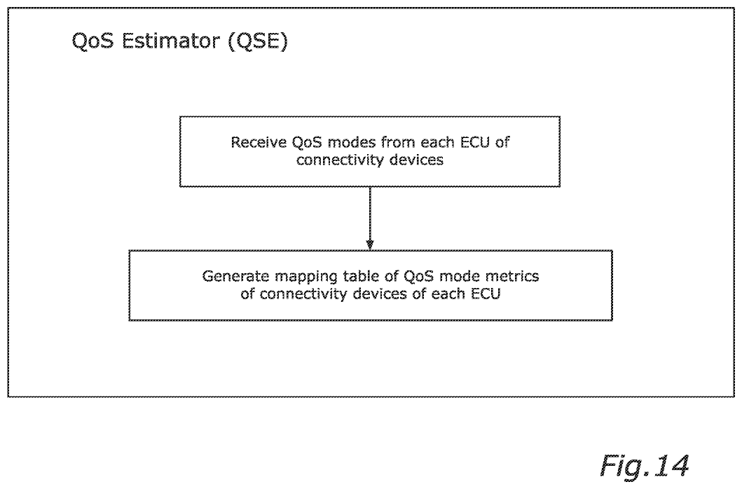

FIG. 14 a functional block diagram of an exemplary QoS estimator QSE;

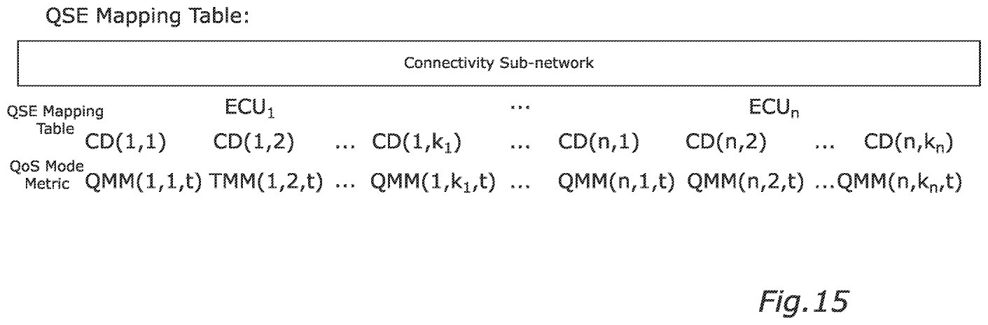

FIG. 15 an exemplary QSE mapping table;

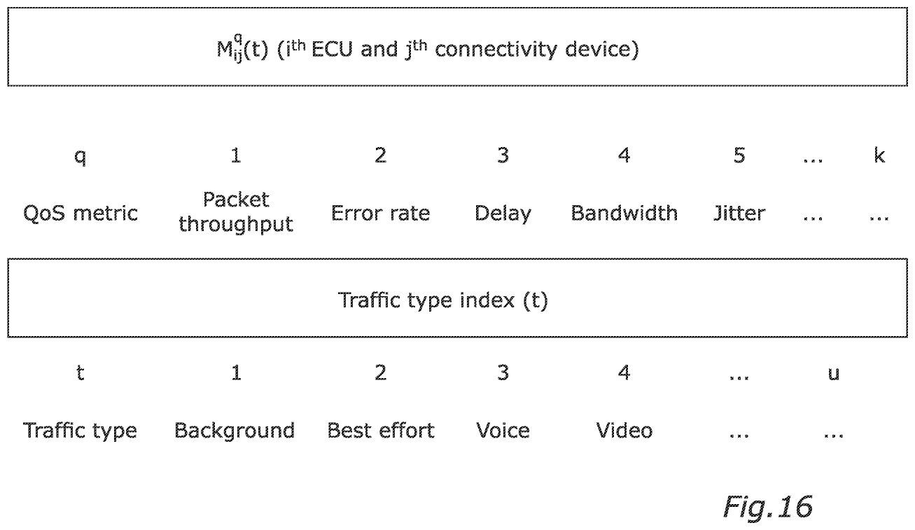

FIG. 16 an exemplary table for QoS mode metric components;

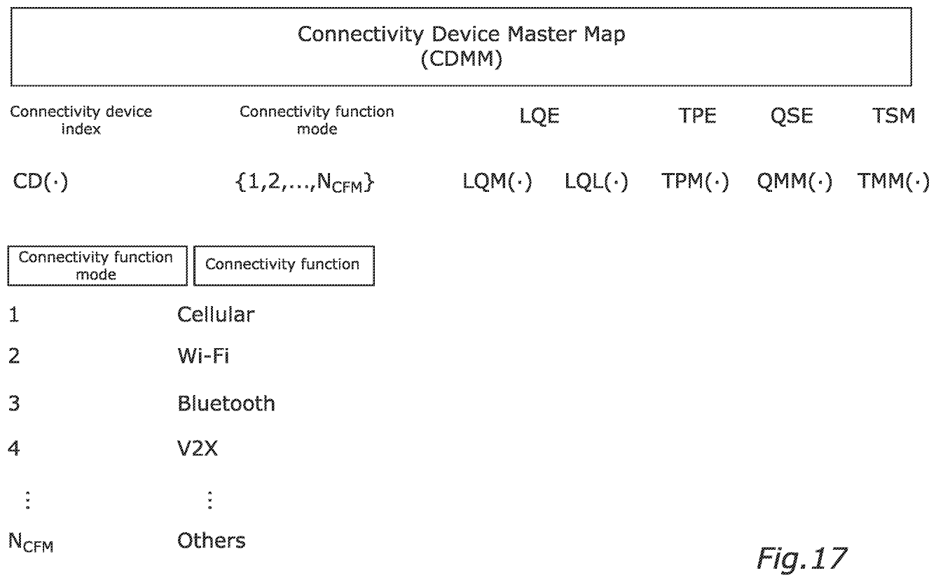

FIG. 17 an exemplary connectivity device master map CDMM;

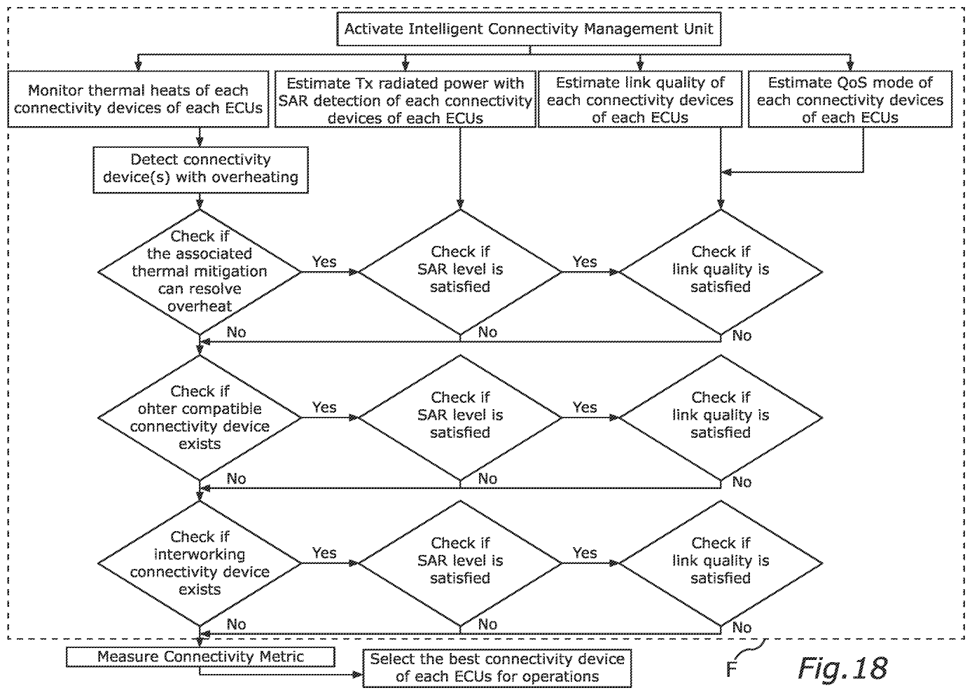

FIG. 18 a flow chart of an embodiment of the inventive method;

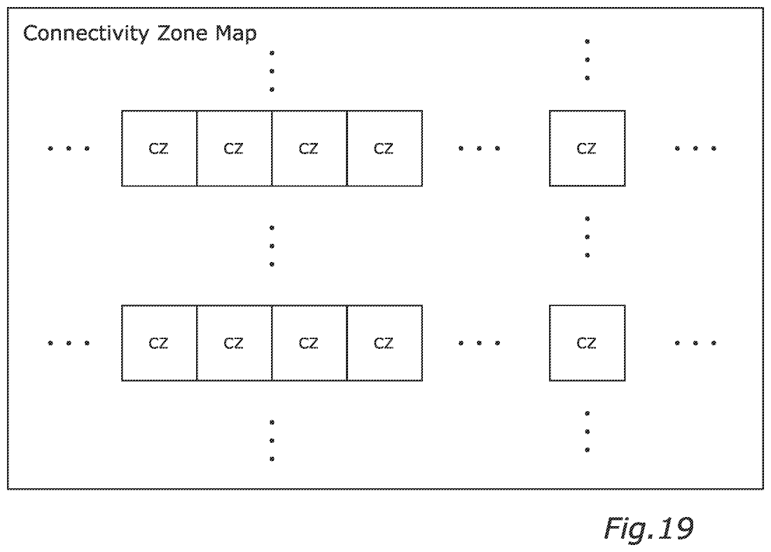

FIG. 19 an exemplary connectivity zone map; and

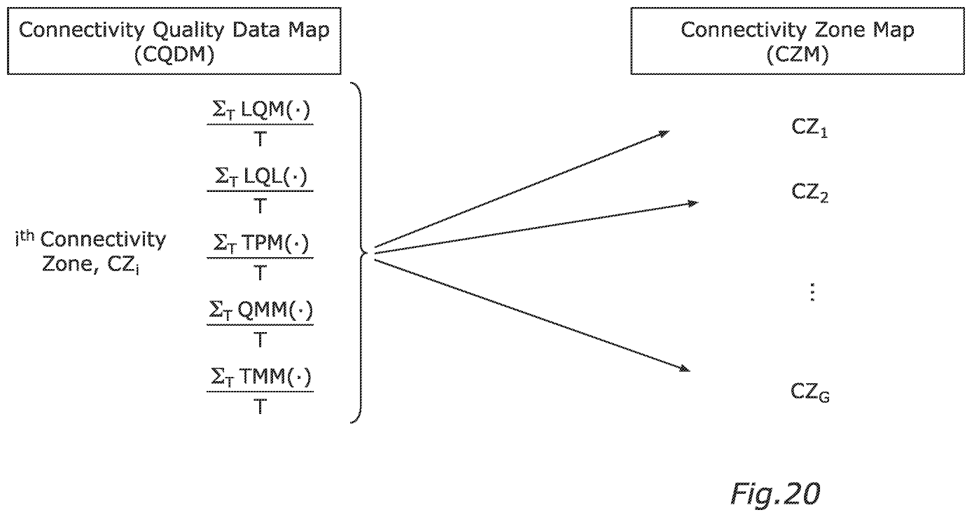

FIG. 20 an exemplary connectivity quality data map CQDM.

The embodiment explained in the following is a preferred embodiment of the invention. However, in the embodiment, the described components of the embodiment each represent individual features of the invention which are to be considered independently of each other and which each develop the invention also independently of each other and thereby are also to be regarded as a component of the invention in individual manner or in another than the shown combination. Furthermore, the described embodiment can also be supplemented by further features of the invention already described.

In the figures elements that provide the same function are marked with identical reference signs.

FIG. 1 shows a vehicle 10 comprising one or several (a number n) connectivity ECUs (ECUᵢ) that each may provide kᵢ connectivity devices for operating one or several of the wireless connection of the shown standards. The vehicle 10 may provide all or only a subset of the shown standards. Each connectivity ECU may be electrically linked to an antenna connectivity system that may comprise one antenna or several antennas. The connectivity ECUs may be connected to a connectivity network domain that may be based, e.g., on an Ethernet. A connected gateway may connect the connectivity network domain to at least one application ECU (not shown) running each at least one application that may signal a demand for a connectivity service. The respective connectivity service may provide a functionality for transmitting data between the respective application and a respective server of a backend server network that may be part of the Internet.

FIG. 2 shows how the application ECUs may be grouped in network domains that may be branches of a switched network. The connected gateway may serve as a switch or gateway. At least one application may be run on an in-vehicle server and/or a high-computing platform. The connectivity network domain may provide the communication control based on connectivity devices for, e.g., cellular, Wi-Fi, bluetooth, broadcast radio. One or more of the following components may be provided the vehicle 10. An infotainment network domain for audio/video, navigation; a chassis network domain for steering control, airbag control, braking system; a powertrain network domain for engine control, transmission control; a body network domain for the instrument cluster, door locking, climate control; an ADAS/AD network domain for sensor fusion control (e.g. Lidar, radar, ultrasonic); a diagnostic network domain for OBD (on-board diagnosis).

As many functions are networked within a domain, but are also networked with one another across domain boundaries, the connected gateway may provide as a central hub or functional block for network communication to interconnect with different ECUs across different domains (e.g., interdomain backbone). It may also handle authentication, protocol conversion, data integrity and secure key storage and/or management for both external devices connected to the vehicle. Authentication makes sure that only valid devices are attached to the gateway. It can also include partial connectivity service of its own, e.g. eCall. The whole sub-networks under the gateway can be either logical or physical units or both for in vehicle connections. Each network domain may contain one or several ECUs. Connectivity is also part of a network domain with other domains such as, e.g., infotainment, chassis, body, powertrain. Additionally, or alternatively, in-vehicle server and high-computing platform can be connected to in-vehicle network.

FIG. 3 illustrated an exemplary design of a connectivity ECU. The described connectivity sub-network has a collection of physical/logical connections with connectivity ECUs that may contain one or several of the following connectivity devices:
Cellular: 2G/3G/4G and 5G
Wi-Fi: 802.11abgn, ac, ax
WiGig: 802.11ad, ay
Bluetooth/LE: BT4.x/5.x
Emergency call: eCall, ERA-GLONASS, E911
Location positioning: GNSS (GPS/Galileo/Glonass/Beidu)
Cellular IOT: LTE-M, NB-IOT
Broadcast: FM/AM/DAB/SDARS radio
V2X: Cellular V2X (3GPP), DSRC (802.11p)
UWB: 802.15.4
Short-range: NFC, RFID
Ethernet: 802.3/1, OPEN Alliance
one or more of: NTN, PLC, CAN HS/FD.

More connectivity devices can be added to this sub-network and it is not limited to the already mentioned solutions. Only a sub-set of the listed connectivity devices may be provided. Multiple connectivity sub-networks can be added to connected gateway.

FIG. 4 illustrated an exemplary detailed design of a connectivity ECU. A connectivity ECU may have a set of connectivity devices with various configurations depending on target applications and functionalities of each ECU. With the configured connectivity devices in ECU, the default devices may also include at least one of a processor, microcontroller, memory, HSM, I/O interfaces and peripheral devices for UF connections to external network or devices. For radio access functional support, the antenna configuration system is connected to connectivity ECUs through connectors.

FIG. 5 shows a functional block diagram of a connectivity management unit that is termed as intelligent connectivity management unit ICMU, as it provided several decision making algorithms. The ICMU may be implemented in the connectivity gateway or in one or several connectivity ECUs or in a separate ECU.

Intelligent Connectivity Management Unit (ICMU) may designed as a functional unit of managing the whole connectivity sub-network with the associated connectivity ECUs. The main roles of ICMU may include at least one of:
To monitor thermal status of each connectivity services across all connectivity ECUs,
To estimate connectivity link quality information reported from all connectivity ECUs,
To estimate different QoS modes supported by each connectivity ECUs and specific connectivity services,
To determine target power level of each connectivity services chosen from each connectivity ECUs,
To generate connectivity metrics for connectivity selection process,
To select the best connectivity services from each connectivity ECUs to support each QoS modes.

Key benefits that can be realized with the ICMU, can be:
To enhance thermal management of each connectivity services across all connectivity ECUs,
To minimize use of power consumption of all activated connectivity services,
To optimize seamless connectivity serviceal operations across all connectivity ECUs for crossfunctional use cases and backup connectivity support,
To provide workaround of meeting SAR requirements with electromagnetic power radiation,
To provide information to generate connectivity zone map that can be integrated with other map layers such as navigation map, HD map, ADAS map.

FIG. 6 shows a functional block diagram of the Thermal Status Monitor (TSM) of FIG. 5. Thermal conditions of connectivity devices of each ECUs in the connectivity sub-network are monitored. Temperature sensors are placed close to connectivity devices of each ECUs. Their sensor data that can be reported back to ICMU as input to TSM. For example, an onboard thermistor can be implemented.

FIG. 7 illustrates how the TSM can provide temperature mapping table for mapping of the temperature values to one of m temperature levels TL (temperature ranges) of each connectivity devices of each ECUs. It may generate a look-up table of available thermal mitigation modes of connectivity devices of each ECUs. As an example, TL₁ may range from 105° C. to 85° C. and TLₘ may range from −15° C. to −25° C.

FIG. 8 illustrates an example of a mitigation look-up table. A thermal mitigation mode, TMM(⋅), indicates valid mitigation scheme applied to each threshold level (THi). Examples of a TMM are: fan speed value, setting the cooling power, data throttling.

The thermal management function may get temperature sensor reading and multi-level mitigation states can be defined with thermal threshold/mitigation decision. For this purpose, thermal management configuration file can be also generated to interact with device temperature reading status for mitigation operations. On the other hand, there are other possible mechanical/physical approaches to lessen thermal heat such as thermal spreading with heat pipe/TIM (thermal interface material), shielding, and fan use, just to name some examples.

FIG. 9 illustrates a functional block diagram of the Link Quality Estimator, LQE, of FIG. 5. Link quality information may be reported to the ICMU from connectivity devices of each ECUs in connectivity sub-network. The link quality information contains a metric of estimating the current quality of the connectivity channel (e.g., RSSI, SNR, PER, SIR). The LQE may generate a look-up table (FIG. 10) of link quality metrics LQM of each connectivity devices of each ECUs. Link quality metric, LQM(⋅), indicates a set of measurements such as, e.g., at least one of SNR, RSSI, PER, SIR. The LQE may generate mapping table (FIG. 11) of link quality levels LQL of each connectivity devices of each ECUs. The respective link quality level LQL indicates the connection quality of each given connectivity devices such as, e.g., highly stable, stable, unstable, highly unstable.—MOS with quantization into P levels.

FIG. 12 illustrates a functional block diagram of the Tx Power Estimator TPE of FIG. 5. Tx power information may be reported to ICMU from connectivity devices of each ECUs in connectivity subnetwork. The Tx power information indicates average power (the time-averaged power level of data packets) transmitted for data transfer with the given connectivity device. The TPE may generate mapping table of Tx power delta metrics of each connectivity devices of each ECUs (FIG. 13). The Tx power delta metric TPM(⋅) indicates the difference between average radiated power (the time-averaged power level of data packets) and the required power level for SAR based on proximity sensor data:

TPM(i,j)≙P_{SAR_pwr}(i,j)−P_{T}(i,j)

wherein
TPM(⋅) is the delta value of difference between radiated power and SAR-based required power (i^{th} ECU and j^{th} connectivity device),
P_{T}(i,j) is the average radiated power as described above,
P_{SAR_PWR}(i,j) is the allowed or required power to meet SAR level.

FIG. 14 illustrates a functional block diagram of the QoS Estimator QSE of FIG. 5. QoS modes supported by each connectivity ECUs and specific connectivity services and/or connectivity devices are reported to the ICMU from connectivity devices of each ECUs in connectivity sub-network. A QoS mode indicates radio traffic type/class of service such as, e.g., at least one of background, best effort, video, voice, based on data, streaming, interactive services with real-time and non-real-time applications. Each radio traffic type/class of service contains the required bandwidth, priority level, delay, jitter, packet throughput, error rate. This may be pre-defined by the skilled person. Each connectivity type has its own QoS mechanism such as, e.g., QCI (QoS class indicator) for cellular.

For each connectivity device, a QMM-value may be determined resulting a QSE mapping table (FIG. 15) based on the calculation:

QMM(i,j,t)≙Σ_{q=1}^{k}w_{q}×f_{q}(Mᵢⱼ^{q}(t))

wherein
QMM(⋅) is the QoS mode metric of the i-th ECU and its j-th connectivity device,
t is the traffic type index,
w_{q} is a pre-defined weight value for signaling a pre-defined priority level of q-th QoS mode metric, and
f_{q}(Mᵢⱼ^{q}) is a pre-defined function of the q-th QoS mode component Mᵢⱼ^{q}.

The value of w_{q} and the function f_{q} may be adapted to the demands of the skilled person. f_{q} may be, e.g., the identity function. Values for w_{q} may be in the range from 0 to 1.

The mapping from a traffic type t to the q-th QoS mode component Me may be implemented on the basis of a table as shown in FIG. 16. If an application that is signaling a demand for a connectivity service is determined to be of traffic type t, the table shows the demand for the specific values for the QoS mode component Mᵢⱼ^{q}. Recommended values for Me are available in the prior art.

The Connectivity Metric Generator CMG may generate a metric to be used for connectivity mode selection criteria across connectivity devices of each ECUs. It provides the basis for maximizing a weighted utility function R(i,j), e.g., total throughput, with minimization of total average radiated power P_{T} and power consumption P_{C} across connectivity devices of ECUs. The weighted utility function R(i,j) is defined as a function of QMM(⋅) and LQM(⋅). A weight factor w_{i,j} may be dynamically determined by prioritizing applications/services supported by connectivity devices of ECUs. As more functional connectivity solutions are integrated into in-vehicle system architecture, the overall power consumption management is significant to utilize the limited power budget. For example, Tx power can be dynamically adjusted to link connection channel status so that some amount of power consumption can be saved. Also duty cycle can be adapted to save power depending on service modes and connectivity types.

The CMG may then generate a connectivity device master map CDMM (as exemplarily shown in FIG. 17) based on the following inputs from other functional blocks:
Thermal status
Link quality status
Tx power level
QoS mode

It may generate the connectivity device master map containing updates of output from the above functional blocks. This functionality is the basis of Connectivity Mode Selector CMS. This may provide the indices i,j for an optimized choice of a connectivity device i,j:

$$max \frac{{\sum }_{i , j} {w}_{i , j} R ( i , j )}{{\sum }_{i , j} {P}_{T} ( i , j ) + {\sum }_{i , j} {P}_{C} ( i , j )} ,$$

wherein
w_{i,j} is a pre-defined weighting factor of the i-th ECU and its j-th connectivity device,
R(i,j) is a utility function of the i-th ECU and its j-th connectivity device with
R(i,j)=6{QMM(i,j,t), LQM(i,j)}, wherein δ{ } is a pre-defined function for combining QMM and LQM.
P_{T}(i,j) is the average radiated power of i^{th} ECU and j^{th} connectivity device as described above,
P_{C}(i,j) is the power consumption of i^{th} ECU and j^{th} connectivity device as described above.

The connectivity evaluation function can be regarded as an inverse cost function. Thus, minimizing a cost function is equivalent to maximizing the connectivity evaluation function.

If several connectivity devices are to be used, a single connectivity device may be determined and then its indices i,j are excluded from the sum operator and the maximization operation is repeated until the required number of connectivity devices has been determined.

FIG. 18 illustrates the steps of a method for selecting the at least one connectivity device for providing a connectivity service of a requesting application.

The Connectivity Mode Selector CMS may manage the selection process of connectivity devices of each connectivity ECUs to support each QoS modes on demand based on the output of the CMG that considers the following conditions of each connectivity devices:
Link quality status,
Power radiation level,
Thermal heat/power dissipation level, and
QoS mode on demand.

An additional thermal management function F may be provided for relieving or excluding overheated connectivity devices. The Connectivity Mode Selector CMS finally selects the best connectivity devices of each connectivity ECUs.

FIG. 19 illustrates a connectivity zone map CZM that may be generated for planning a journey of the vehicle and/or for providing a map of current connectivity conditions. Vehicles can be in any location of connectivity zone, CZ, blocks. CZ blocks can be dynamically adjusted and/or configured. For each CZ block, time-averaged metrics from the connectivity device master map CDMM can be provided from a connectivity quality data map CQDM.

FIG. 20 illustrates a possible way of generating the CQDM. For each connectivity zone CZᵢ a time average over a time interval T may be calculated for one or several of the metrics from the CDMM.

CZ block size and CQDM signaling time interval may be set by the skilled person.

After each time interval T, the newly generated mapping data of CQDM with CZM can be fused with other information about HD map and location-positioning data. CQDM and CZM can be also integrated with other map layers such as navigation map, HD map, ADAS map.

The Connectivity Quality Data Map, CQDM, is generated based on connectivity device master map CDMM to indicate in-vehicle connectivity device quality level for each link connection. It is the quantized data set/subset of CDMM with the pre-defined average time interval T. The Connectivity Zone Map, CZM, is the quantized map of geographical locations for mapping with CQDM. The CQDM is mapped onto geographical location information to generate CZM (see FIG. 19). It is thus combined with the CQDM.

The CQDM for the positioned CZ may be sent to a backend server. The backend server taking the CQDM and the CZM from vehicle 10 and from further other vehicles can generate big data for incremental map updates about connectivity zone information.

The CQDM for the positioned CZ may be used for incremental map updates about connectivity zone information. This generates historic connectivity map data. For a future journey of the vehicle this allows for predicting which connectivity device may maximize the connectivity evaluation function in a future time interval and/or for a region that lies ahead on a planned driving route of the vehicle. This can be integrated into the estimate of how stable a connectivity service will be during a journey (e.g. the LQM), if a specific connectivity device will be used. The vehicle may also be provided with external map data from said server such that the vehicle may also predict the link quality for regions that it did not travel before.

The ICMU may also provide one or several of the following modes of operations for a driver's choice:

| ICMU Mode | ICMU Operation Setting |
|---|---|
| Off Mode | ICMU operation is disabled |
| Eco Mode | The default connectivity device operation (pre- |
| | configurable) is enabled only |
| Passenger Mode | Passenger Service SIM (PSS) based connectivity |
| | device operation is prioritized |
| Business Mode | Vehicle Service SIM (VSS) based connectivity |
| | device operation is prioritized |
| Comfort Mode | Full-featured operation of ICMU |

Additional functionalities may be provided, especially:
Using the output of ICMU, in-vehicle body control can be leveraged to adjust passenger seats to optimize its position against SAR effect.
In setting the best route of destination location for driving, CZM is utilized to provide the connectivity-friendly routes on top of the legacy route generation mechanism.
In the perspective of performance and functionalities, the enhancements of in-vehicle connectivity solutions by having ICMU include:
   Minimum use of power consumption
   Improved thermal management
   Seamless in-vehicle connectivity operations for cross-functional use cases and backup connectivity support
Support of connectivity zone map based routes for autonomous driving.

This setup tackles the challenges so as to resolve major part of them based on a set of different approaches. Based on this setup, the following aim is achieve:
Minimum use of power consumption,
Improved thermal management,
Robust connectivity service operations against mechanical limitations,
Seamless in-vehicle connectivity operations for cross-functional use cases and backup connectivity support,
Alternative way of meeting SAR with limited power radiation,
Enhanced map functionality for autonomous driving with connectivity zone map.

Overall, the example shows how a connectivity management unit, ICMU, is provided by the invention.

### REFERENCE SIGNS

10 vehicle
CDMM connectivity device master map
CQDM connectivity quality data map
F thermal management function
ICMU connectivity management unit
LQE link quality estimator
QMM QoS mode metric
t Traffic type
TH Threshold level
TMM Thermal mitigation mode
TPE Transmission power estimator
TPM Tx power delta metric
TSM thermal status monitor

1. A method for managing at least one wireless connectivity service for at least one application in a vehicle, wherein the vehicle comprises several connectivity devices configured to run at least one wireless connection, wherein the respective wireless connectivity service is based on the at least one wireless connection, wherein operating a connectivity management unit, ICMU, performs the following steps:
operating a link quality estimator, LQE, configured to determine a respective link quality metric, LQM, of the respective wireless connection of each of the connectivity devices,
operating a transmission, Tx, power estimator, TPE, configured to determine a respective average radiated transmission power P_{T}, and a respective SAR level P_{SAR_PWR} and a respective power consumption P_{C} of each connectivity device,
operating a Quality-of-service, QoS, estimator, QSE, configured to determine a respective QoS mode metric, QMM, that quantifies a suitability of the respective wireless connection of each of the connectivity devices to perform the respective wireless connectivity service for at least one pre-defined traffic type t,
operating a connectivity metric generator, CMG, configured to provide a connectivity device master map, CDMM, that lists output of the LQE, the TPE, and the QSE,
when the at least one application signals a respective demand for the respective wireless connectivity service, determining for the respective connectivity service the respective traffic type t based on a service class of the application,
operating a connectivity mode selector, CMS, configured to select for each application at least one of the connectivity devices for which a connectivity evaluation function yields a maximized result, wherein the connectivity evaluation function maps a pre-defined data set or data sub-set of the CDMM for the determined traffic type t onto a respective evaluation value,
establishing the respective wireless connectivity service using the respective wireless connection of each selected connectivity device.

2. The method according to claim 1,
wherein the connectivity devices are provided in n electronic control units, ECU, with index i and each ECU, provides kᵢ of the connectivity devices, such that each connectivity device is identified by an index i of its ECU, and an index j of the kᵢ connectivity devices of the ECU, and wherein for selecting the at least connectivity device a following maximization of the connectivity evaluation function is performed:
$$max \frac{{\sum }_{i , j} {w}_{i , j} R ( i , j )}{{\sum }_{i , j} {P}_{T} ( i , j ) + {\sum }_{i , j} {P}_{C} ( i , j )} ,$$
wherein w_{i,j} is a pre-defined weighting factor of an i-th ECU and its j-th connectivity device, R(i,j) is a utility function of the i-th ECU and its j-th connectivity device with R(i,j)=δ{QMM(i,j,t), LQM(i,j)}, wherein δ{ } is a pre-defined function for combining QMM and LQM.

3. The method according to claim 1, further comprising the steps of the connectivity management unit, ICMU:
detecting if one of the connectivity devices is overheating,
if an overheated connectivity device is detected, initiating a thermal management function, and if the thermal management function fails, excluding the overheated connectivity device from the selection.

4. The method according to claim 3, wherein the thermal management function comprises:
operating a thermal status monitor, TSM, configured to determine available respective thermal mitigation modes, TMMs, for different temperature ranges of each connectivity device, and switching from a current TMM to another new TMM, if temperature of the connectivity device is in a temperature range of the new TMM, and/or
switching to another one of the connectivity devices if the wireless connection of the other connectivity device is compatible with the wireless connection of the overheated connectivity device according to a predefined compatibility criterion, and/or
finding an interworking connectivity device and routing a part of a data traffic of the overheated connectivity device to the interworking connectivity device instead of the overheated connectivity device.

5. The method according to claim 4, wherein operating the TSM comprises:
receiving sensor data for each of the connectivity devices,
generating mapping table of temperature levels, TLs, of the connectivity devices,
generating a look-up table of the TMMs with temperature threshold levels, THs, for each of the connectivity devices, wherein each of the TLs, describes a temperature range comprising several temperature values and wherein the respective temperature threshold level, TH, indicates one of the TLs.

6. The method according to claim 4, wherein the TMMs comprise at least one of: data throttling, maximum Tx power back-off, limiting/disabling data transmission modes, shutdown, service mode reduction.

7. The method according to claim 3, wherein the thermal management function comprises:
verifying that applying the thermal management function results in a transmission power P_{T} of each wireless connection below the respective SAR level P_{SAR_PWR} for each connectivity device and/or
verifying that applying the thermal management function results in a link quality that meets required QMM for each running connectivity service.

8. The method according to claim 1, wherein operating the TPE comprises:
receiving proximity sensor data signaling a human body proximity to a respective antenna configuration used by the respective connectivity device,
determining the respective SAR level P_{SAR_PWR} based on the proximity sensor data.

9. The method according to claim 8,
wherein operating the TPE further comprises:
receiving Tx power information of each of the connectivity devices,
generating a mapping table of Tx power delta metrics TPM of the connectivity devices for the connectivity device master map, CDMM, wherein the Tx power delta metrics, TPM, is calculated for the respective connectivity device as:
TPM=P_{SAR_PWR}−P_{T},
wherein TPM is required to be larger or equal to 0.

10. The method according to claim 1, wherein operating the LQE comprises:
receiving pre-defined link quality information for each of the connectivity devices,
from the link quality information generating a look-up table of link quality metrics, LQM, of the connectivity devices, wherein the link quality metrics, LQM, each indicates a set of measurements, in particular SNR, RSSI, PER, and/or
from the link quality information and/or from the link quality metrics, LQMs, generating a mapping table of link quality levels, LQLs, wherein the link quality level, LQL, indicates connection quality of each given connectivity devices, in particular as one of highly stable, stable, unstable, highly unstable, into P levels.

11. The method according to claim 1, wherein the connectivity devices are provided in n electronic control units, ECU, with index i and each ECU, provides kᵢ of the connectivity devices, such that each connectivity device is identified by an index i of its ECUᵢ and an index j of the kᵢ connectivity devices of the ECUᵢ and wherein operating the QoS estimator, QSE, comprises:
receiving supported k QoS mode components Mᵢⱼ^{q} of the connectivity devices,
generating a mapping table of QoS mode metrics, QMMs, of the connectivity devices, wherein the respective QMM is calculated as
$$QMM ( i , j , t ) {=}^{Δ} {\sum }_{q = 1}^{k} {w}_{q} \times {f}_{q} ( {M}_{i j}^{q} ( t ) ) .$$
wherein
QMM(i,j,t) is the QMM of i-th ECU and its j-th connectivity device,
t is traffic type index,
w_{q} is a pre-defined weight value for signaling a pre-defined priority level of q-th QMM, and
f_{q}(Mᵢⱼ^{q}) is a pre-defined function of the q-th QoS mode component Mᵢⱼ^{q}.

12. The method according to claim 11, wherein as the QoS mode components Mᵢⱼ^{q} at least one of the following quantities is provided: packet throughput, error rate, delay, bandwidth, jitter.

13. The method according to claim 1, wherein as the pre-defined traffic types t, at least one of background, best effort, voice, video is provided.

14. The method according to claim 1, further comprising:
generating a Connectivity Quality Data Map, CQDM, based on the CDMM to indicate an in-vehicle connectivity device quality level for each wireless connection by time-wise quantizing a pre-defined data set or data subset of the CDMM using a pre-defined averaging function for a pre-defined averaging time interval T, and/or
generating a Connectivity Zone Map, CZM, by geographically quantizing geographical locations by mapping with the Connectivity Quality Data Map, CQDM, into pre-defined connectivity zones CZᵢ such that the data of the CQDM is mapped onto geographical location information depending on the location where they apply.

15. Electronic control unit with an electronic processor circuitry, wherein the electronic control unit is designed to control data traffic between a) at least one electronic control unit that is running at least one application and b) at least one electronic control unit with at least one connectivity device and wherein the electronic processor circuitry is configured to perform the method according claim 1.

16. The electronic control unit according to claim 15, wherein the connectivity devices are provided in n electronic control units, ECU, with index i and each ECU, provides kᵢ of the connectivity devices, such that each connectivity device is identified by an index i of its ECU′ and an index j of the kᵢ connectivity devices of the ECU, and wherein for selecting the at least one connectivity device the following maximization of the connectivity evaluation function is performed:
$$max \frac{{\sum }_{i , j} {w}_{i , j} R ( i , j )}{{\sum }_{i , j} {P}_{T} ( i , j ) + {\sum }_{i , j} {P}_{C} ( i , j )} ,$$
wherein w_{i,j} is a pre-defined weighting factor of an i-th ECU and its j-th connectivity device, R(i,j) is a utility function of the i-th ECU and its j-th connectivity device with R(i,j)=δ{QMM(i,j,t), LQM(i,j)}, wherein δ{ } is a pre-defined function for combining QMM and LQM.

17. The electronic control unit according to claim 15, wherein the method further comprises the steps of the ICMU:
detecting if one of the connectivity devices is overheating,
if an overheated connectivity device is detected, initiating a thermal management function, and if the thermal management function fails, excluding the connectivity device from the selection.

18. The electronic control unit according to claim 17, wherein the thermal management function comprises:
operating a thermal status monitor, TSM, configured to determine available respective thermal mitigation modes, TMMs, for different temperature ranges of each connectivity device, and switching from a current TMM to another new TMM, if temperature of the connectivity device is in a temperature range of the new TMM, and/or
switching to another one of the connectivity devices if the wireless connection of the other connectivity device is compatible with the wireless connection of the overheated connectivity device according to a predefined compatibility criterion, and/or
finding an interworking connectivity device and routing a part of a data traffic of the overheated connectivity device to the interworking connectivity device instead of the overheated connectivity device.

19. The electronic control unit according to claim 18, wherein operating the TSM comprises:
receiving sensor data for each of the connectivity devices,
generating mapping table of temperature levels, TLs, of the connectivity devices,
generating a look-up table of the TMMs with temperature threshold levels, THs, for each of the connectivity devices, wherein each of the TLs describes a temperature range comprising several temperature values and wherein the respective temperature threshold level, TH, indicates one of the TLs.

20. The electronic control unit according to claim 19, wherein the TMMs comprise at least one of: data throttling, maximum Tx power back-off, limiting/disabling data transmission modes, shutdown, service mode reduction.
